(19) United States
(12) Patent Application Publication
(10) Pub. No.: US 2026/0203965 A1
(43) Pub. Date: Jul. 16, 2026

(54) LOOKUP TABLE SELECTION METHOD AND NON-TRANSITORY COMPUTER READABLE STORAGE MEDIUM

(71) Applicant: Realtek Semiconductor Corporation, Hsinchu (TW)

(72) Inventors: Yu-Shen WANG, Hsinchu (TW); Cheng Yueh CHEN, Hsinchu (TW); Hua Yi NI, Hsinchu (TW); Wen-Hsia KUNG, Hsinchu (TW)

(21) Appl. No.: 19/284,692

(22) Filed: Jul. 30, 2025

(30) Foreign Application Priority Data
Jan. 14, 2025 (TW) 114101558

(51) Int. Cl. G06T 11/00; G06T 3/4046; G06T 7/00; G06T 7/90

(52) U.S. Cl. CPC G06T 11/10; G06T 3/4046; G06T 7/0002; G06T 7/90; G06T 2207/10024; G06T 2207/20081; G06T 2207/20084; G06T 2207/30168

(57) ABSTRACT

A lookup table selection method is provided, comprising: dividing received image data into training image data and validation image data; performing, by an artificial intelligence model, a neural network training based on the training image data, so as to generate a plurality of lookup tables, wherein each of the lookup tables has a node number, and the node numbers of the lookup tables are different from each other; converting the validation image data into a plurality of converted validation image data based on the lookup tables; comparing the plurality of converted validation image data with the validation image data, so as to generate a plurality of conversion scores corresponding to the plurality of converted validation image data; and selecting one of the lookup tables as a selected lookup table according to the conversion scores and a plurality of memory scores respectively corresponding to the conversion scores.

### RELATED APPLICATIONS

This application claims priority to Taiwan Application Serial Number 114101558, filed on Jan. 14, 2025, which is herein incorporated by reference in its entirety.

### BACKGROUND

### Technical Field

The present disclosure relates to an image processing technology. More particularly, the present disclosure relates to a lookup table selection method and a non-transitory computer readable storage medium that can automatically select the most suitable lookup table when performing image processing.

### Description of Related Art

In today's image processing technology, using a lookup table (LUT) to convert images is a common technique. By using a (one-dimensional or three-dimensional) lookup table to digitally process image data, the color, color gamut and other related parameters of the image can be effectively adjusted.

However, since the lookup tables often occupy a large amount of memory space and there is no fast and effective way to reduce the lookup tables in today's image processing technology, the current industry practice is usually to limit the node number in the lookup table to a specific number (usually 33 or 17). Therefore, how to effectively reduce the node number in the lookup table to save the memory space occupied by the lookup table is one of the issues in this field.

### SUMMARY

A lookup table selection method is provided in the present disclosure. The lookup table selection method comprises: (a) dividing, by a computing circuit, image data into training image data and validation image data; (b) performing, by an artificial intelligence model, a neural network training based on the training image data, so as to generate a plurality of lookup tables, wherein each of the plurality of lookup tables has a node number, and the node numbers of the plurality of lookup tables are different from each other; (c) converting, by the computing circuit, the validation image data into a plurality of converted validation image data based on the plurality of lookup tables; (d) comparing, by the computing circuit, the plurality of converted validation image data with the validation image data, so as to generate a plurality of conversion scores corresponding to the plurality of converted validation image data; and (e) selecting, by the computing circuit, one of the plurality of lookup tables as a selected lookup table according to the plurality of conversion scores and a plurality of memory scores respectively corresponding to the plurality of conversion scores.

A non-transitory computer readable storage medium is provided in the present disclosure. The non-transitory computer readable storage medium stores a plurality of computer readable instructions. When the plurality of computer readable instructions are executed for selecting a selected lookup table suitable for an application scenario, by one or a plurality of processors, the one or the plurality of processors is configured to perform the following operations: (a) receiving image data and dividing the image data into training image data and validation image data; (b) performing a neural network training based on the training image data, so as to generate a plurality of lookup tables, wherein each of the plurality of lookup tables has a node number, and the node numbers of the plurality of lookup tables are different from each other; (c) converting the validation image data into a plurality of converted validation image data based on the plurality of lookup tables; (d) comparing the plurality of converted validation image data with the validation image data, so as to generate a plurality of conversion scores corresponding to the plurality of converted validation image data; and (e) selecting one of the plurality of lookup tables as the selected lookup table according to the plurality of conversion scores and a plurality of memory scores respectively corresponding to the plurality of conversion scores.

With the lookup table selection method and the non-transitory computer readable storage medium of the present disclosure, the accuracy of the lookup table can be enhanced by using a convolutional neural network, and the lookup table that best suits the current application scenario can be selected by scoring various lookup tables and performing weighted calculations.

### BRIEF DESCRIPTION OF THE DRAWINGS

The present disclosure can be more fully understood by reading the following detailed description of the embodiment, with reference made to the accompanying drawings as follows.

FIG. 1 is a flowchart of a lookup table selection method in accordance with some embodiments of the present disclosure.

FIG. 2 is a flowchart of some steps of the lookup table selection method in accordance with some embodiments of the present disclosure.

FIG. 3 is a schematic diagram of a lookup table in accordance with some embodiments of the present disclosure.

FIG. 4 is a flowchart of some steps of the lookup table selection method in accordance with some embodiments of the present disclosure.

FIG. 5 is a flowchart of some steps of the lookup table selection method in accordance with some embodiments of the present disclosure.

### DETAILED DESCRIPTION

Reference will now be made in detail to the present embodiments of the disclosure, examples of which are illustrated in the accompanying drawings. Wherever possible, the same reference numbers are used in the drawings and the description to refer to the same or like parts.

Unless the context requires otherwise, the terms “a”, “an” and “the” may refer to one or more items. It will be further understood that the terms “comprising”, “including”, “having” and the like herein specify the features, regions, integers, steps, operations, elements and/or components described therein, but do not exclude the described or additional features, regions, integers, steps, operations, elements, components and/or groups thereof.

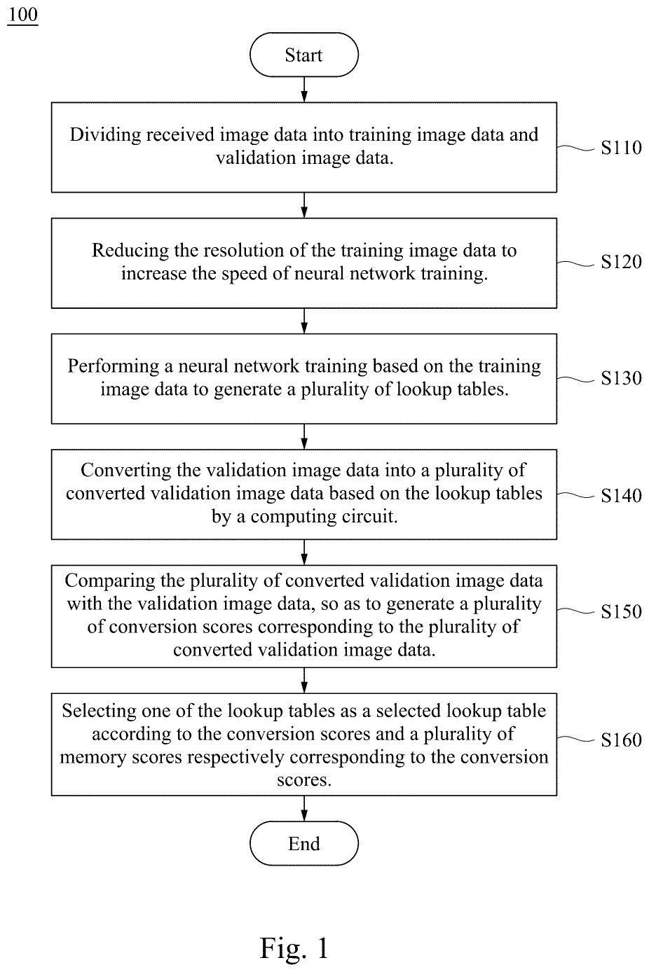

FIG. 1 is a flowchart of a lookup table selection method 100 in accordance with some embodiments of the present disclosure. The lookup table selection method 100 is applicable to the selection of a lookup table in a specific application scenario. In some embodiments, the lookup table selection method 100 comprises steps S110, S120, S130, S140, S150 and S160.

In step S110, a computing circuit (or computing device) receives image data (e.g., a plurality of pictures) and divides the image data into training image data and validation image data. The training image data and the validation image data are used for training and validating an artificial intelligence (AI) model in subsequent steps, which will be described in detail in the following paragraphs. In some embodiments, the proportion of the training image data in the image data is greater than the proportion of the validation image data in the image data. For example, the training image data accounts for 75% of the image data, and the validation image data accounts for 25% of the image data. After step S110 is completed, step S120 is executed next.

In step S120, the computing circuit reduces the resolution of the training image data, so as to increase the speed of the neural network training in subsequent steps. In some embodiments, the computing circuit reduces the resolution of the training image data by using a down sampling technique in step S120. After step S120 is completed, step S130 is executed next.

In step S130, the artificial intelligence model performs a neural network training based on the training image data, so as to generate a plurality of lookup tables. In some embodiments, each of the lookup tables generated in step S130 has a different node number and different node locations.

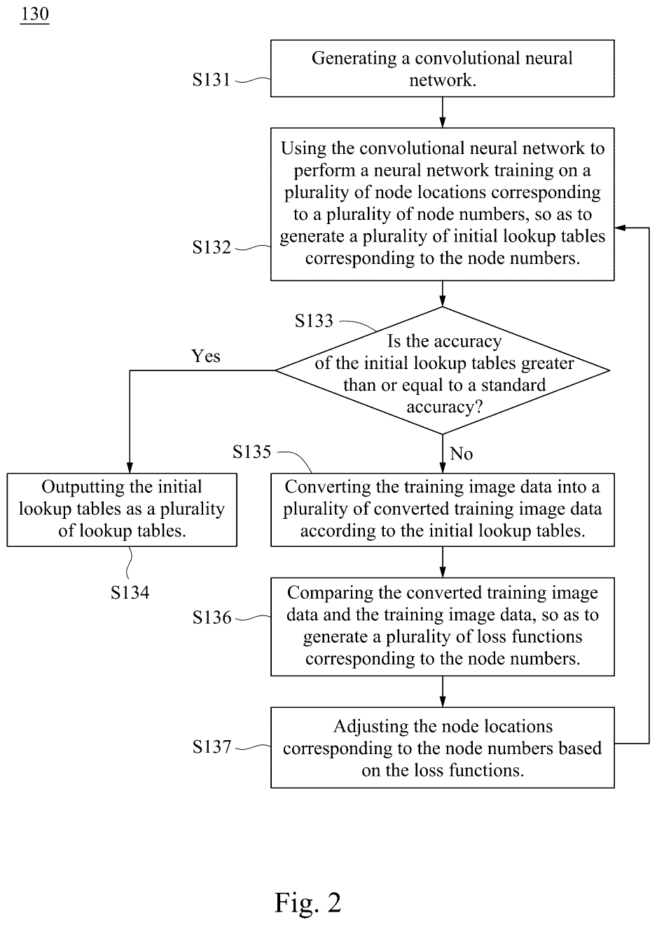

Regarding detailed steps of the artificial intelligence model generating the lookup tables in step S130, please refer to FIG. 2. FIG. 2 is a detailed flowchart of step S130 of the lookup table selection method 100 in accordance with some embodiments of the present disclosure. In some embodiments, step S130 further comprises steps S131-S137.

In step S131, the artificial intelligence model generates a neural network. In some embodiments, the neural network is a convolutional neural network (CNN), which is configured to perform convolution operations to generate a neural network. After step S131 is completed, step S132 is executed next.

In step S132, the artificial intelligence model uses the convolutional neural network generated in step S131 to perform a neural network training on the node locations corresponding to the different node numbers, so as to generate a plurality of initial lookup tables corresponding to the node numbers. For example, when the node number is set to be between 17 and 33, first, for a lookup table with 33 nodes, the artificial intelligence model will be trained based on the 33 node locations of the lookup table, so as to obtain an initial lookup table corresponding to 33 nodes; next, for a lookup table with 32 nodes, the artificial intelligence model will be trained based on the 32 node locations of the lookup table, so as to obtain an initial lookup table corresponding to 32 nodes, and so on. Therefore, with the training of the artificial intelligence model, the initial lookup tables corresponding to the node numbers ranging from 17 to 33 can be obtained.

In some embodiments, the convolutional neural network used in the present disclosure comprises a plurality of fully connected layers, and each of these fully connected layers comprises a plurality of neurons. In some embodiments, for a lookup table, the number of neurons in each fully connected layer is equal to the node number of the lookup table. For example, for a lookup table with 17 nodes, each fully connected layer of the convolutional neural network will have 17 neurons. The convolutional neural network uses the comparison of the influence of the feature value of each fully connected layer (corresponding to the node location) on the result as the main training target. It should be noted that those skilled in the art should be able to understand the training method of the “convolutional neural network”, and for the sake of brevity, it will not be repeated here.

After step S132 is completed, step S133 is executed next. In step S133, the artificial intelligence model determines whether the accuracy of the initial lookup tables generated in step S132 is greater than or equal to a standard accuracy. In some embodiments, the term “accuracy” as used in the present disclosure refers to the accuracy of a lookup table compared to another lookup table with infinite accuracy. In some embodiments, the standard accuracy can be manually set to a specific value. When the accuracy of the initial lookup tables generated in step S132 is greater than or equal to the standard accuracy, step S134 is executed next; when the accuracy of the initial lookup tables generated in step S132 is less than the standard accuracy, step S135 is executed next.

In step S134, the artificial intelligence model determines that the initial lookup tables generated after training meet the required accuracy, and thus outputs these initial lookup tables as lookup tables for the computing circuit to perform image conversion. After step S134 is completed, step S140 is executed next.

In step S135, the artificial intelligence model determines that the initial lookup tables generated after training do not meet the required accuracy and the convolutional neural network needs to be trained further. Therefore, in step S135, the computing circuit converts the training image data into a plurality of converted training image data according to the plurality of initial lookup tables generated in step S132. After step S135 is completed, step S136 is executed next.

In step S136, the artificial intelligence model compares the converted training image data generated in step S135 and the training image data received in step S110, so as to generate a plurality of loss functions corresponding to the converted training image data (i.e. corresponding to the various node numbers). It should be noted that those skilled in the art should be able to understand the relevant content of the “loss function” used in neural network training. For the sake of brevity, it will not be repeated here. After step S136 is completed, step S137 is executed next.

In step S137, the artificial intelligence model adjusts the node locations corresponding to the various node numbers based on the loss functions calculated in step S136. After step S137 is completed, step S132 is executed again. Through steps S135-S137, the convolutional neural network can be repeatedly trained to ensure that the lookup tables obtained through training have a sufficient accuracy, thereby improving the performance of image conversion.

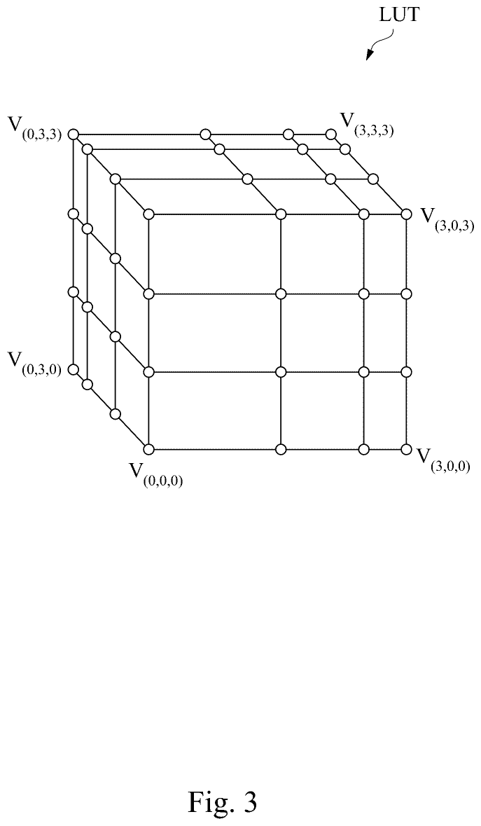

In some embodiments, the node locations of the lookup tables generated by the lookup table selection method 100 of the present disclosure are arranged in a non-uniform lookup table configuration. Please refer to FIG. 3. FIG. 3 is a schematic diagram of a lookup table LUT generated by the lookup table selection method 100 in accordance with some embodiments of the present disclosure. In the embodiment of FIG. 3, the lookup table LUT comprises a plurality of nodes, and these nodes are located at different node locations (i.e., different coordinate points) in the three-dimensional coordinate system, such as node coordinate point V(0,0,0), node coordinate point V(3,3,3), etc. Furthermore, the node locations of the lookup table LUT are not uniform. For example, there are four nodes between the node coordinate point V(0,0,0) and the node coordinate point V(3,0,0), but the distances between any two adjacent nodes of these four nodes may not be equal. With this non-uniform lookup table configuration, the node locations can be adjusted for different application scenarios, so as to reduce errors during image conversion.

Please refer to FIG. 1 again. After step S134 in step S130 is completed, step S140 is executed next. In step S140, the computing circuit converts the validation image data into a plurality of converted validation image data based on the lookup tables trained in step S130. After step S140 is completed, step S150 is executed next.

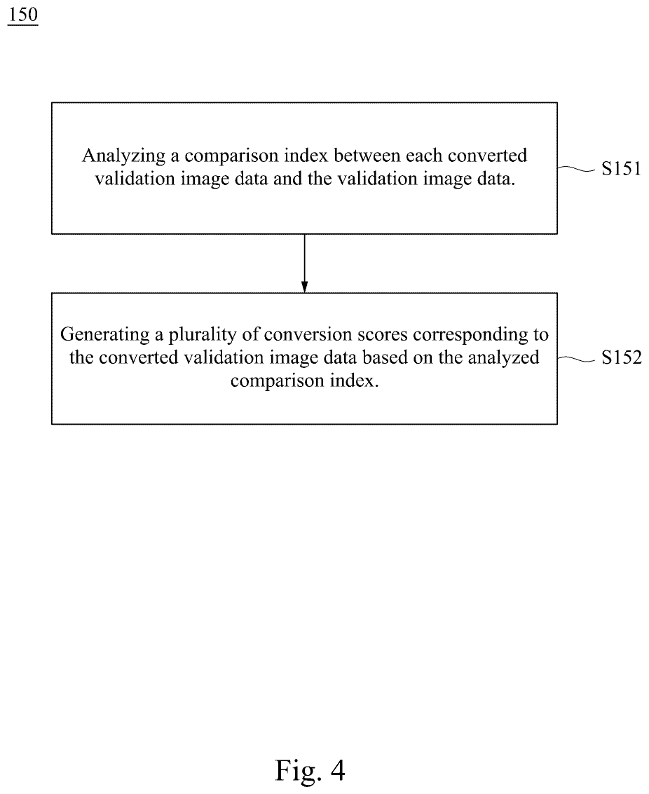

In step S150, the computing circuit compares the plurality of converted validation image data with the validation image data, so as to generate a plurality of conversion scores corresponding to the plurality of converted validation image data. Regarding detailed steps of calculating the conversion scores in step S150, please refer to FIG. 4. FIG. 4 is a detailed flowchart of step S150 of the lookup table selection method 100 in accordance with some embodiments of the present disclosure. In some embodiments, step S150 further comprises steps S151 and S152.

In step S151, the computing circuit analyzes a comparison index between each converted validation image data and the validation image data, wherein the comparison index is used to indicate the degree of similarity/difference between the converted validation image data and the validation image data. In some embodiments, the comparison index is related to the color pixel codes or the color tristimulus values of the image. For example, the comparison index can be implemented by peak signal-to-noise ratio (PSNR), structural similarity index (SSIM), other index for evaluating image correlation or any combination of the above indexes. Specifically, the PSNR indicates the degree of image distortion from the perspective of the signal, and is related to at least one of the red pixel code, blue pixel code and green pixel code of the converted validation image data and the validation image data. SSIM tends to indicate the similarity of images from the perspective of human eyes, and is related to at least one of the chromaticity, brightness and luminance of the converted validation image data and the validation image data. After step S151 is completed, step S152 is executed next.

In step S152, the computing circuit generates a plurality of conversion scores corresponding to each converted validation image data based on the comparison index (e.g., PSNR, SSIM or a combination of the two) obtained by analysis. In some embodiments, the closer the converted validation image data is to the validation image data, the higher the conversion score calculated in step S152 will be.

Please refer to FIG. 1 again. After step S152 in step S150 is completed, step S160 is executed next. In step S160, the computing circuit selects one of the lookup tables as a selected lookup table according to the plurality of conversion scores obtained in step S150 and a plurality of memory scores respectively corresponding to the conversion scores. In some embodiments, when the memory space occupied by the lookup table is larger, the memory score generated in step S160 will be lower. In other words, the more nodes the lookup table has, the lower the memory score will be.

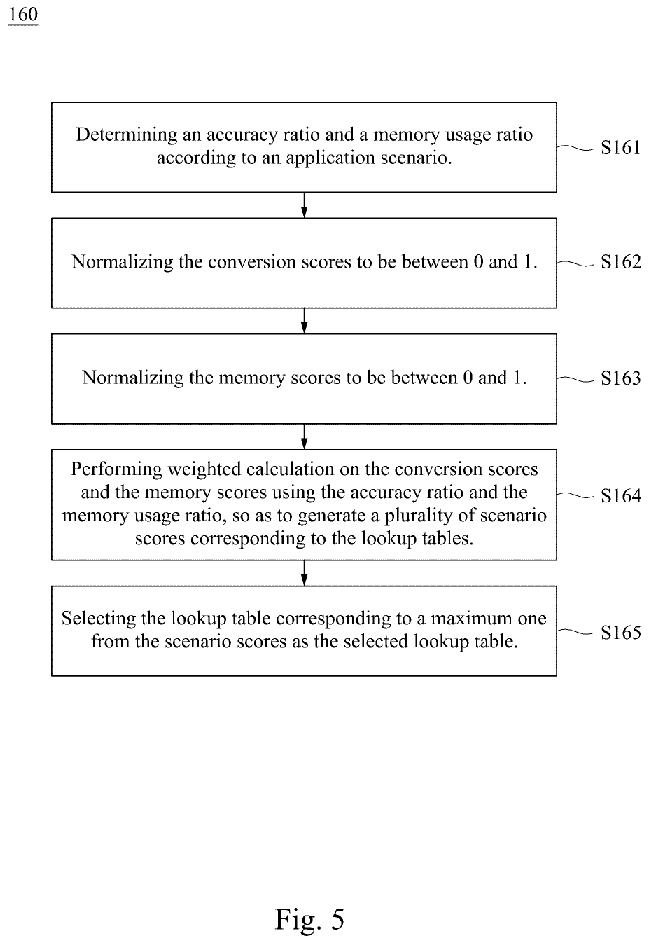

Regarding detailed steps of selecting the selected lookup table in step S160, please refer to FIG. 5. FIG. 5 is a detailed flowchart of step S160 of the lookup table selection method 100 in accordance with some embodiments of the present disclosure. In some embodiments, step S160 further comprises steps S161-S165.

In step S161, the computing circuit determines an accuracy ratio and a memory usage ratio according to the application scenario. In some embodiments, different application scenarios may correspond to different combinations of accuracy ratios and memory usage ratios. For example, when a device is in a low memory usage requirement, the accuracy ratio will be reduced and the memory usage ratio will be increased. At this time, the selection of the lookup table will focus on saving memory usage and will be less concerned about the accuracy of image conversion. On the contrary, when a device has no special restrictions on memory requirements, the accuracy ratio will be increased and the memory usage ratio will be reduced. At this time, the selection of the lookup table will focus on the accuracy of conversion rather than total memory usage. After step S161 is completed, step S162 is executed next.

In step S162, the computing circuit normalizes each of the conversion scores to be between 0 and 1. After step S162 is completed, step S163 is executed next.

In step S163, the computing circuit normalizes each of the memory scores to be between 0 and 1. After step S163 is completed, step S164 is executed next.

In step S164, the computing circuit performs a weighted calculation on the conversion scores and the memory scores by using the accuracy ratio and the memory usage ratio determined in step S161, so as to generate a plurality of scenario scores corresponding to the plurality of lookup tables. After step S164 is completed, step S165 is executed next.

In step S165, the computing circuit selects a maximum one from the plurality of scenario scores, and selects the lookup table corresponding to the maximum scenario score as the selected lookup table.

For example, in the embodiment of Table 1 below, the lookup tables with 33, 29, 25, 21 and 17 nodes have different conversion scores and memory scores, respectively, and the accuracy ratio and memory usage ratio corresponding to this application scenario are 0.3 and 0.7, respectively. By performing weighted calculations on the conversion scores and the memory scores with the accuracy ratio and the memory usage ratio respectively, the scenario scores of these lookup tables can be obtained. In the embodiment of Table 1 below, since the lookup table with 21 nodes has the largest scenario score, the computing circuit will finally select this lookup table as the selected lookup table.

TABLE 1

| Node number in the lookup table | 33 | 29 | 25 | 21 | 17 |
|---|---|---|---|---|---|
| Conversion score | 0.81 | 0.75 | 0.6 | 0.53 | 0.44 |
| Accuracy ratio | 0.3 | | | | |
| Memory score | 0.23 | 0.4 | 0.53 | 0.61 | 0.64 |
| Memory usage ratio | 0.7 | | | | |
| Scenario score | 0.404 | 0.505 | 0.551 | 0.586 | 0.58 |

It should be noted that the node numbers and their corresponding values of the lookup tables in Table 1 are only examples, and are not intended to limit the present disclosure. Other node numbers and their corresponding values are within the scope of the present disclosure. In some embodiments, the lookup table selection method 100 may select from a plurality of lookup tables having 17 to 33 nodes. In other embodiments, the lookup table selection method 100 may select from a plurality of lookup tables having a number of nodes ranging from greater than 17 to 33.

In addition, it should be noted that the number and order of the steps in the lookup table selection method 100 of the present disclosure are merely examples, and are not intended to limit the present disclosure. Other numbers and orders of steps are within the scope of the present disclosure. In some embodiments, step S120 may be omitted, so when step S110 is completed, step S130 will be directly executed. In some embodiments, step S162 and step S163 may be executed simultaneously. In some embodiments, step S162 and step S163 may be omitted, so when step S161 is completed, step S164 will be directly executed.

The present disclosure provides a non-transitory computer readable storage medium storing a plurality of computer readable instructions, when the plurality of computer readable instructions are executed by one or a plurality of processors, the one or the plurality of processors is configured to perform the lookup table selection method 100 described above. In some embodiments, the non-transitory computer readable storage medium is an electronic, magnetic, optical, electromagnetic, infrared and/or a semiconductor system (or apparatus or device). For example, the non-transitory computer readable storage medium comprises a semiconductor or solid-state memory, a magnetic tape, a removable computer diskette, a random access memory (RAM), a read-only memory (ROM), a rigid magnetic disk, and/or an optical disk. In some embodiments using optical disks, the non-transitory computer readable storage medium comprises a compact disk-read only memory (CD-ROM), a compact disk-read/write (CD-R/W) and/or a digital video disc (DVD).

With the lookup table selection method 100 and the non-transitory computer-readable storage medium disclosed in the present document, the accuracy of image conversion can be improved by training lookup tables with different node numbers using a convolutional neural network, and the lookup table that best suits the current application scenario can be selected by scoring and weighting the trained lookup tables.

Those skilled in the art may make some changes and embellishments within the spirit and scope of the present disclosure Based on the foregoing embodiments, all changes and embellishments made to the present disclosure also fall with the scope of protection of the present disclosure.

What is claimed is:

1. A lookup table selection method, comprising:
(a) dividing, by a computing circuit, image data into training image data and validation image data;
(b) performing, by an artificial intelligence model, a neural network training based on the training image data, so as to generate a plurality of lookup tables, wherein each of the plurality of lookup tables has a node number, and the node numbers of the plurality of lookup tables are different from each other;
(c) converting, by the computing circuit, the validation image data into a plurality of converted validation image data based on the plurality of lookup tables;
(d) comparing, by the computing circuit, the plurality of converted validation image data with the validation image data, so as to generate a plurality of conversion scores corresponding to the plurality of converted validation image data; and
(e) selecting, by the computing circuit, one of the plurality of lookup tables as a selected lookup table according to the plurality of conversion scores and a plurality of memory scores respectively corresponding to the plurality of conversion scores.

2. The lookup table selection method of claim 1, wherein between step (a) and step (b), the lookup table selection method further comprises:
reducing, by the computing circuit, a resolution of the training image data, so as to increase the speed of the neural network training.

3. The lookup table selection method of claim 1, wherein step (d) comprises:
analyzing, by the computing circuit, a comparison index between each of the plurality of converted validation image data and the validation image data; and
generating, by the computing circuit, the plurality of conversion scores corresponding to the plurality of converted validation image data based on the comparison index.

4. The lookup table selection method of claim 1, wherein a proportion of the training image data in the image data is greater than a proportion of the validation image data in the image data.

5. The lookup table selection method of claim 1, wherein step (e) comprises:
determining, by the computing circuit, an accuracy ratio and a memory usage ratio according to an application scenario;
performing, by the computing circuit, a weighted calculation on the plurality of conversion scores and the plurality of memory scores, by using the accuracy ratio and the memory usage ratio, so as to generate a plurality of scenario scores corresponding to the plurality of lookup tables; and
selecting, by the computing circuit, a lookup table corresponding to a maximum one from the plurality of scenario scores as the selected lookup table.

6. The lookup table selection method of claim 5, wherein in step (e), before the performing, by the computing circuit, the weighted calculation on the plurality of conversion scores and the plurality of memory scores, by using the accuracy ratio and the memory usage ratio, step (e) further comprises:
normalizing, by the computing circuit, the plurality of conversion scores to be between 0 and 1; and
normalizing, by the computing circuit, the plurality of memory scores to be between 0 and 1.

7. The lookup table selection method of claim 1, wherein step (b) comprises:
(b1) generating, by the artificial intelligence model, a convolutional neural network;
(b2) using, by the artificial intelligence model, the convolutional neural network to perform the neural network training on a plurality of node locations corresponding to the node numbers, so as to generate a plurality of initial lookup tables corresponding to the node numbers; and
(b3) in response to an accuracy of the plurality of initial lookup tables being greater than or equal to a standard accuracy, outputting, by the artificial intelligence model, the plurality of initial lookup tables as the plurality of lookup tables.

8. The lookup table selection method of claim 7, wherein in step (b), in response to the accuracy of the plurality of initial lookup tables being less than the standard accuracy, after step (b2), step (b) further comprises:
converting, by the computing circuit, the training image data into a plurality of converted training image data according to the plurality of initial lookup tables;
comparing, by the artificial intelligence model, the plurality of converted training image data and the training image data, so as to generate a plurality of loss functions corresponding to the node numbers;
adjusting, by the artificial intelligence model, the plurality of node locations corresponding to the node numbers based on the plurality of loss functions; and
executing step (b2) again.

9. The lookup table selection method of claim 7, wherein the plurality of node locations of the plurality of lookup tables are arranged in a non-uniform lookup table configuration.

10. The lookup table selection method of claim 7, wherein the convolutional neural network comprises a plurality of fully connected layers, and each of the plurality of fully connected layers comprises a plurality of neurons, wherein the number of the plurality of neurons in each of the plurality of fully connected layers is equal to the number of the node numbers.

11. A non-transitory computer readable storage medium, storing a plurality of computer readable instructions, when the plurality of computer readable instructions are executed for selecting a selected lookup table suitable for an application scenario, by one or a plurality of processors, the one or the plurality of processors is configured to perform the following operations:
(a) receiving image data and dividing the image data into training image data and validation image data;
(b) performing a neural network training based on the training image data, so as to generate a plurality of lookup tables, wherein each of the plurality of lookup tables has a node number, and the node numbers of the plurality of lookup tables are different from each other;
(c) converting the validation image data into a plurality of converted validation image data based on the plurality of lookup tables;
(d) comparing the plurality of converted validation image data with the validation image data, so as to generate a plurality of conversion scores corresponding to the plurality of converted validation image data; and
(e) selecting one of the plurality of lookup tables as the selected lookup table according to the plurality of conversion scores and a plurality of memory scores respectively corresponding to the plurality of conversion scores.

12. The non-transitory computer readable storage medium of claim 11, wherein between operation (a) and operation (b), the one or the plurality of processors is further configured to perform the following operations:
reducing a resolution of the training image data, so as to increase the speed of the neural network training.

13. The non-transitory computer readable storage medium of claim 11, wherein operation (d) comprises:
analyzing a comparison index between each of the plurality of converted validation image data and the validation image data; and
generating the plurality of conversion scores corresponding to the plurality of converted validation image data based on the comparison index.

14. The non-transitory computer readable storage medium of claim 11, wherein a proportion of the training image data in the image data is greater than a proportion of the validation image data in the image data.

15. The non-transitory computer readable storage medium of claim 11, wherein operation (e) comprises:
determining an accuracy ratio and a memory usage ratio according to the application scenario;
performing a weighted calculation on the plurality of conversion scores and the plurality of memory scores, by using the accuracy ratio and the memory usage ratio, so as to generate a plurality of scenario scores corresponding to the plurality of lookup tables; and
selecting a lookup table corresponding to a maximum one from the plurality of scenario scores as the selected lookup table.

16. The non-transitory computer readable storage medium of claim 15, wherein in operation (e), before the performing the weighted calculation on the plurality of conversion scores and the plurality of memory scores, by using the accuracy ratio and the memory usage ratio, operation (e) further comprises:
normalizing the plurality of conversion scores to be between 0 and 1; and
normalizing the plurality of memory scores to be between 0 and 1.

17. The non-transitory computer readable storage medium of claim 11, wherein operation (b) comprises:
(b1) generating a convolutional neural network;
(b2) using the convolutional neural network to perform the neural network training on a plurality of node locations corresponding to the node numbers, so as to generate a plurality of initial lookup tables corresponding to the node numbers; and
(b3) in response to an accuracy of the plurality of initial lookup tables being greater than or equal to a standard accuracy, outputting the plurality of initial lookup tables as the plurality of lookup tables.

18. The non-transitory computer readable storage medium of claim 17, wherein after operation (b2) in operation (b), in response to the accuracy of the plurality of initial lookup tables being less than the standard accuracy, operation (b) further comprises:
converting the training image data into a plurality of converted training image data according to the plurality of initial lookup tables;
comparing the plurality of converted training image data and the training image data, so as to generate a plurality of loss functions corresponding to the node numbers;
adjusting the plurality of node locations corresponding to the node numbers based on the plurality of loss functions; and
executing operation (b2) again.

19. The non-transitory computer readable storage medium of claim 17, wherein the plurality of node locations of the plurality of lookup tables are arranged in a non-uniform lookup table configuration.

20. The non-transitory computer readable storage medium of claim 17, wherein the convolutional neural network comprises a plurality of fully connected layers, and each of the plurality of fully connected layers comprises a plurality of neurons, wherein the number of the plurality of neurons in each of the plurality of fully connected layers is equal to the number of the node numbers.
